(19) United States
(12) Patent Application Publication
(10) Pub. No.: US 2007/0263573 A1
(43) Pub. Date: Nov. 15, 2007

(54) On-device radio logging in smartphone

(76) Inventors: Yoon Kean Wong, Redwood City, CA (US); Justin Evan Manus, San Francisco, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/433,591

(22) Filed: May 12, 2006

(51) Int. Cl. H04Q 7/24

(52) U.S. Cl. 370/338

(57) ABSTRACT

Radio logging data of a smartphone is collected on the smartphone itself using an on-device radio logging application that runs on the smartphone itself. The collected radio logging data is provided to a host computer at a later time after the radio logging data is saved, or as the radio logging data is collected, or to a remote computer as the radio logging data is collected.

### BACKGROUND OF THE INVENTION

1. Field of the Invention

The present invention relates to radio logging in a smartphone including cellular telephone capabilities, and more specifically, to radio logging in a smartphone including telephone capabilities using an on-device radio logging application running on the smartphone itself.

2. Description of the Related Art

Smartphones are typically handheld devices that integrate personal information management or other computing capabilities with mobile telephone capabilities in the same device. This includes adding mobile telephone functions to already capable Personal Digital Assistants (PDAs), or putting computing (“smart”) capabilities, such as PDA functions, into a mobile telephone.

Smartphones are often designed for use with a host computer so that software and data on the smartphone can be managed and exchanged between the host computer and the smartphones. Smartphones typically communicate with the host computer through a transport that is based upon a certain communication protocol, such as USB (Universal Serial Bus), a serial interface, IEEE 1394 interface, etc.

There is often a need to collect and monitor data relating to the characteristics and quality of the cellular telephone functions of the smartphone. For example, cellular telephone carriers often require that a radio logging application be available to collect and monitor data relating to the characteristics and quality of the cellular telephone functions of the smartphone or the radio or the network to which the radio is connected (herein referred to as “radio logging”).

Conventional smartphones typically do not have on-device radio logging applications. Rather, the radio logging applications for conventional smartphones reside and run on the host computer that is used with the smartphone and are used for testing and development before consumers can buy the smartphone. The radio logging application communicates with the conventional smartphone over the transport when communication is established between the host computer and the smartphone, and sends instructions to the smartphone to collect the radio logging data. The collected radio logging data is then transmitted back to the radio logging application on the host computer. Thus, the radio logging application can collect radio logging data only when the smartphones are in communication with the host computer over the transport. It is not possible for the radio logging application to collect radio logging data during normal use of the smartphone when the smartphone is not communicating with the host computer.

Therefore, there is a need for a radio logging application that runs on the smartphone itself. There is also a need for a radio logging application that can collect radio logging data while the smartphone is not in communication with the host computer. There is still a need for a radio logging application that runs on the smartphone but can provide the collected radio logging application to the host computer, when the smartphone is in communication with the host computer.

### SUMMARY OF THE INVENTION

Embodiments of the present invention include a method for collecting radio logging data of a first computing device (e.g., a smartphone) including cellular telephone capabilities using a radio logging application that runs on the first computing device itself. The collected radio logging data is provided to the second computing device, as the radio logging data is collected, or at a later time after being stored on the first computing device.

In one embodiment, the method comprises collecting the radio logging data on the first computing device, saving the radio logging data in the first computing device, and responsive to establishing communication between the first computing device and the second computing device, providing the saved radio logging data to the second computing device. The saved radio logging data may be provided to the second computing device by way of transmission over a transport or a network or by way of a computer readable medium such as a CD-ROM or disk storing the radio logging data. The radio logging data is collected by a first radio logging application running on the first computing device. The saved radio logging data is provided to a second radio logging application running on the second computing device. The radio logging data is collected at a first time and provided to the second radio logging application at a second time later than the first time. Thus, the second radio logging application on the second computing device can receive past radio logging data previously stored in the first computing device, and it becomes possible to time-shift the review of the radio logging data at any time.

In another embodiment, the method comprises establishing communication between the first computing device and the second computing device, responsive to receiving instructions from the second computing device to collect the radio logging data, collecting the radio logging data on the first computing device while the first computing device is in communication with the second computing device, and transmitting the collected radio logging data to the second computing device. The radio logging data is collected by a first radio logging application running on the first computing device and the instructions to collect the radio logging data are provided from a second radio logging application running on the second computing device to the first radio logging application. The radio logging data is transmitted to the second computing device as the radio logging data is being collected on the first computing device. Thus, in this embodiment, a user viewing the collected radio logging data from the second radio logging application “thinks” that the second radio logging application of the second computing device is collecting the radio logging data, although in fact it is the first radio logging application running on the first computing device that actually collects the radio logging data.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. 1A illustrates a host computer communicating with a smartphone that includes an on-device radio logging application, according to one embodiment of the present invention.

FIG. 1B illustrates the hardware architecture of the host computer, according to one embodiment of the present invention.

FIG. 1C illustrates the hardware architecture of the smartphone, according to one embodiment of the present invention.

FIG. 2A is a flowchart illustrating a method of collecting radio logging data, according to one embodiment of the present invention.

FIG. 2B is a flowchart illustrating a method of collecting radio logging data, according to another embodiment of the present invention.

FIG. 2C is a flowchart illustrating a method of collecting radio logging data, according to still another embodiment of the present invention.

FIG. 3 illustrates a remote computer communicating with the smartphone through the host computer over the transport to receive the radio logging data collected in the smartphone, according to one embodiment of the present invention.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

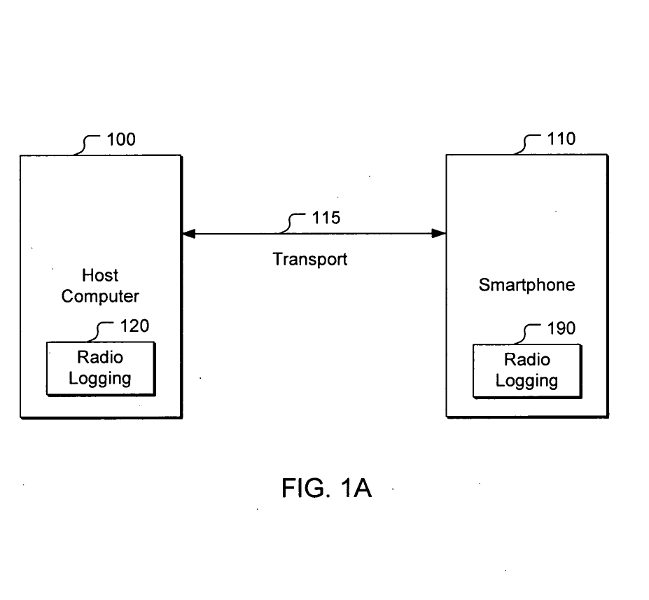

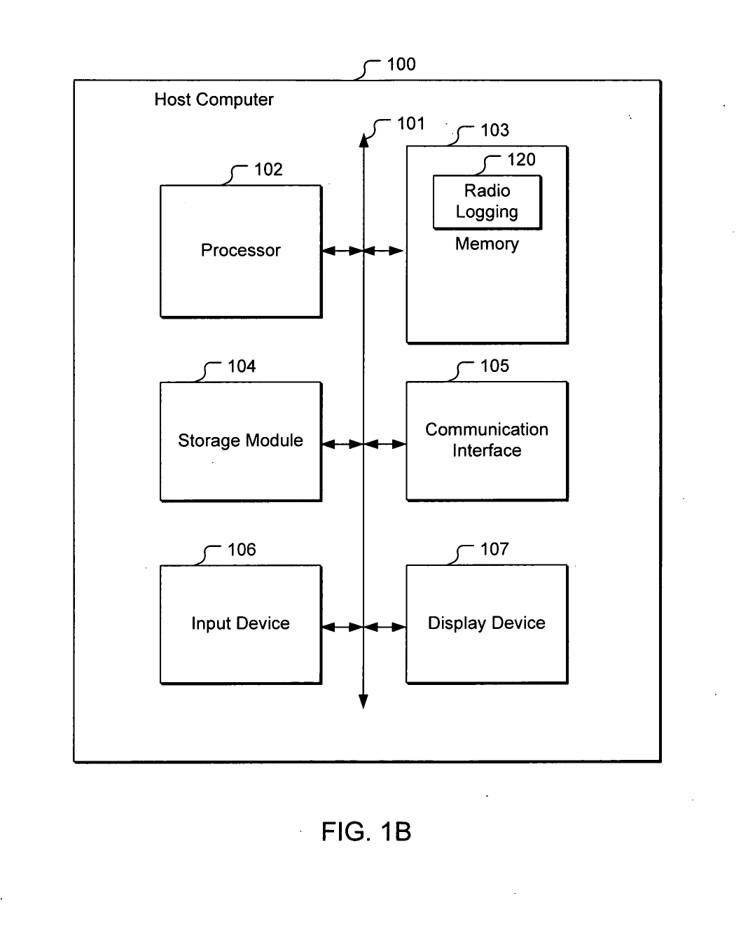

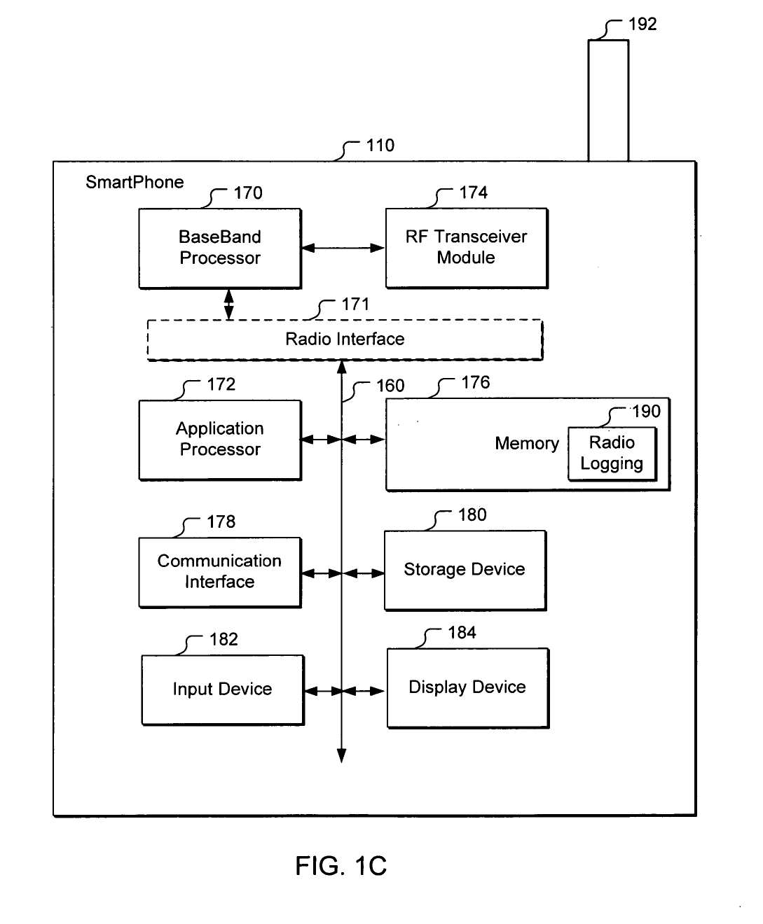

FIG. 1A illustrates a host computer 100 communicating with a smartphone 110 that includes an on-device radio logging application 190, according to one embodiment of the present invention. The host computer 100 may be a conventional personal computer such as a desktop computer or a laptop computer or any other type of computing device, and may also be provided with its own radio logging application 120. According to the embodiment of the present invention, the radio logging application 190 of the smartphone 110 collects the radio logging data on the smartphone. The radio logging application 120 of the host computer 110 does not collect the radio logging data of the smartphone 110 by itself, but later receives the radio logging data collected by the radio logging application 190 on the smartphone 110.

The smartphone 110 may be a personal digital assistant (PDA) with cellular telephone capabilities, a cellular telephone with computing capabilities, or any other type of device that combines computing capabilities with wireless communication capabilities such as cellular telephone. For the purpose of illustration only, the smartphone 110 will be described herein as a PDA with cellular telephone capabilities following the CDMA standard.

In contrast to conventional radio logging applications that reside on the host computer, the on-device radio logging application 190 resides and runs on the smartphone 110. The on-device radio logging application 190 collects and stores radio logging data relating to the cellular telephone communication of the smartphone 110 without having to interact with the radio logging application 120 of the host computer 100. The on-device radio logging application 190 can provide the collected radio logging data to the radio logging application 120 of the host computer 100 at a later time after the radio logging data is collected or simultaneously as the radio logging data is being collected.

The radio logging data is typically data relating to CDMA, EvDO, UMTS, or GSM parameters associated with power management, the RF signals, and the cellular connection of the cellular telephone in the smartphone 110. For example, the radio logging data may include channel rates, power consumed over time, signal strength and other characteristics of transmit and receive signals, arrival times of PNs (Pseudo-Noise Sequences) for a CDMA smartphone, PSCs (primary synchronization channels) for WCDMA (Wide-band CDMA) or UMTS (Universal Mobile Telecommunication System), etc., which are typically measured by monitoring software such as QXDM™ (Qualcomm eXtensible Diagnostic Monitor), CAIT™ (CDMA Air Interface Tester), and UDM™ (Universal Diagnostic Monitor).

In one embodiment, the radio logging application 190 of the smartphone 110 collects and saves the radio logging data, and then provides the collected radio logging data to the host computer 100 upon detecting that communication has been established between the host computer 100 and the smartphone 110 over the transport 115. Thus, the radio logging application 120 of the host computer 100 receives past radio logging data previously stored in the smartphone 110, and it becomes possible to time-shift the review of the radio logging data in any manner.

In another embodiment, the radio logging application 120 of the host computer 100 causes the radio logging application 190 of the smartphone 110 to initiate the collection of the radio logging data while communication between the host computer 100 and the smartphone 110 is established. The radio logging application 190 of the smartphone 110 performs the actual collection of the radio logging data, and provides the collected radio logging data in real time to the radio logging application 120 of the host computer 100 as the radio logging data is being collected. Thus, in this embodiment, a user viewing the collected radio logging data from the radio logging application 120 “thinks” that the radio logging application 120 of the host computer 100 is collecting radio logging data as with conventional radio logging applications running on the host computer 100, although in fact it is the on-device radio logging application 190 running on the smartphone 110 that actually collects the radio logging data.

In still another embodiment, the radio logging application 190 of the smartphone 110 collects and saves the radio logging data, and then provides the collected radio logging data to the host computer 100 as a file by way of a computer readable medium storing the radio logging data file or by transmission of the file over a network. Thus, the radio logging application 120 of the host computer 100 receives past radio logging data previously stored in the smartphone 110, and it becomes possible to time-shift the review of the radio logging data in any manner.

FIG. 1B illustrates the hardware architecture of the host computer 100, according to one embodiment of the present invention. In one embodiment, the host computer 100 is a general purpose personal computer including a processor 102, a memory 103, a storage module (e.g., hard disk drive) 104, an input device (e.g., keyboard, mouse, and the like) 106, a display device 107, and a communication interface 105, exchanging data with one another through a bus 101. The communication interface 105 may include one or more interfaces used to communicate with the smart phone 110 over the transport 115 and exchange data. The communication interface 105 may be a USB (Universal Serial Bus) interface, a serial interface, a parallel interface, a Bluetooth interface, a WiFi (IEEE 802.11) interface, Ethernet, or any other type of wired or wireless communication interface. The storage module 104 stores software that is run by the processor 102 in conjunction with the memory 103 to manage the exchange of data between the host computer 100 and the smartphone 110 over the transport 115. The memory 103 also includes the radio logging application 120 loaded thereon from the storage module 104 for execution by the processor 102. Other application software may also be stored in the storage device 104. Note that not all components of the host computer 100 are shown in FIG. 1C and that certain components not necessary for illustration of the present invention are omitted herein.

FIG. 1C illustrates the hardware architecture of the smartphone 110, according to one embodiment of the present invention. The smartphone 110 includes a radio portion dedicated to cellular telephone functions of the smartphone 110 and a PDA portion dedicated to the computing functions of the smartphone 110. The radio portion and the PDA portion exchange data with each other via a radio interface 171, such as a Serial UART (Universal Asynchronous Receiver Transmitter), USB, or the like. Note that not all components of the smartphone 110 are shown in FIG. 1C and that certain components not necessary for illustration of the present invention are omitted herein.

The radio portion includes a baseband processor 170, an RF transceiver module 174, and an antenna 192. The baseband processor 170 modulates data to be transmitted and demodulates data received in accordance with the protocols of the cellular telephone standard employed by the smartphone 110. For example, the baseband processor 170 may be a CDMA baseband processor that modulates and demodulates data according to the CDMA standard. The baseband processor 170 may perform other functions to control the operation of the radio portion of the smartphone 110, such as determining and gathering information on the performance or characteristics of the cellular communication of the smartphone 110. The RF transceiver 174 amplifies and transmits the data modulated by the baseband processor 170 through the antenna 192 and also receives cellular communication data through the antenna 192 for demodulation by the baseband processor 170.

The PDA portion includes an application processor (or CPU) 172, a memory 176, a communication interface 178, one or more input devices 182, an optional storage device 180, and a display device 184. Each of the components of the PDA portion of the smartphone 110 may communicatively couple through a bus 160.

The application processor 170 is a conventional processor or controller such as an Intel® XScale® processor. The memory 176 is a conventional computing memory such as a random access memory (RAM). The storage module 180 is a conventional long term storage device, for example, a flash memory or a hard disk drive (e.g., magnetic hard drive). The storage module 180 typically stores conventional operating systems such as Palm OS® from PalmSource, Inc. or Windows CE® or Windows Mobile® from Microsoft Corporation for use by the smartphone 110. The memory 176 also includes the on-device radio logging application 190 loaded thereon for execution by the application processor 172. It is noted that the smartphone 110 can also be configured for use with other operating systems, for example, Linux-based operating systems. The input device 182 can be a keyboard, a touch screen, or any other type of input device, and the display device 184 can be a liquid crystal display device or any other type of display device.

Note that the smartphone 110 is a dual processor system in FIG. 1C, including a baseband processor 170 for controlling radio or cellular functions and an application processor 172 for controlling the PDA or computing functions. Therefore, it is possible for certain commands to be executed only on the application processor 172 without accessing the baseband processor 170. For example, the on-device radio logging application 190 is executed by the application processor 172, and collecting the radio logging data by the radio logging application 190 would not affect the operation of the baseband processor 170 other than that the baseband processor 170 provides the radio logging data to the application processor 172 through the radio interface 171.

However, note that the smartphone 110 can also be configured as a single processor system where a single processor (e.g., the baseband processor 170) functions as the processor for both cellular functions and computing functions. In a single processor system, the operation of the single baseband processor 170 would be affected and interrupted by execution of the radio logging application 190 on the baseband processor 170.

The communication interface 178 may include one or more interfaces used to communicate with the host computer 100 over the transport 115 and exchange data. The communication interface 178 may be a USB interface, a serial interface, a parallel interface, a Bluetooth interface, a WiFi interface, Ethernet, or any other type of wired or wireless communication interface.

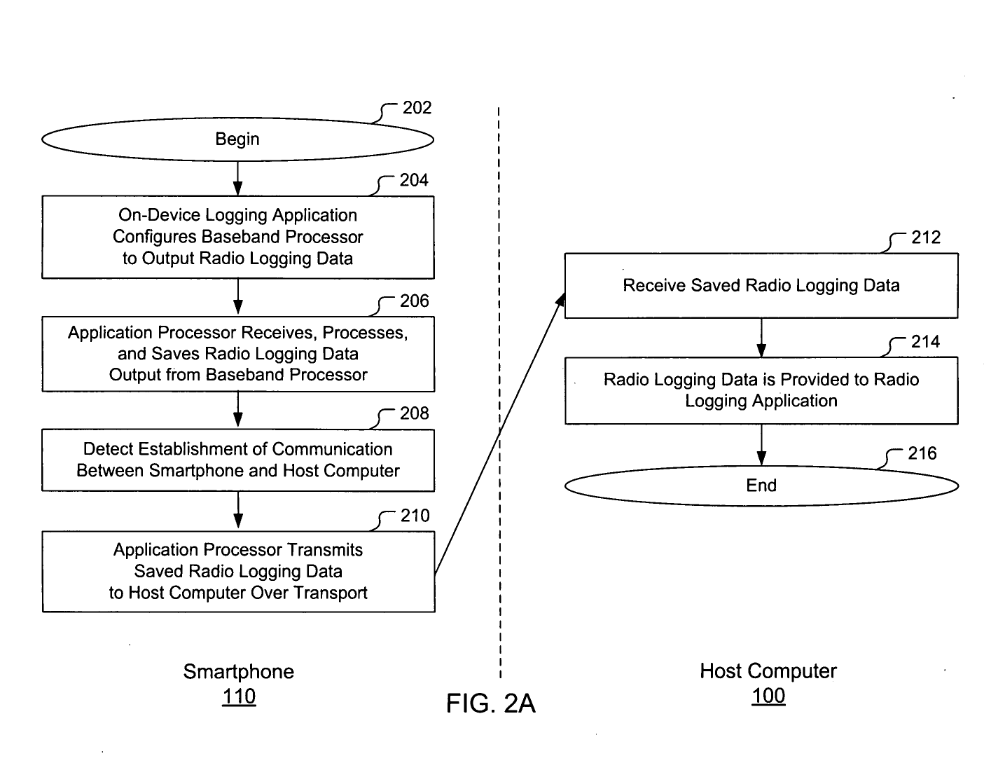

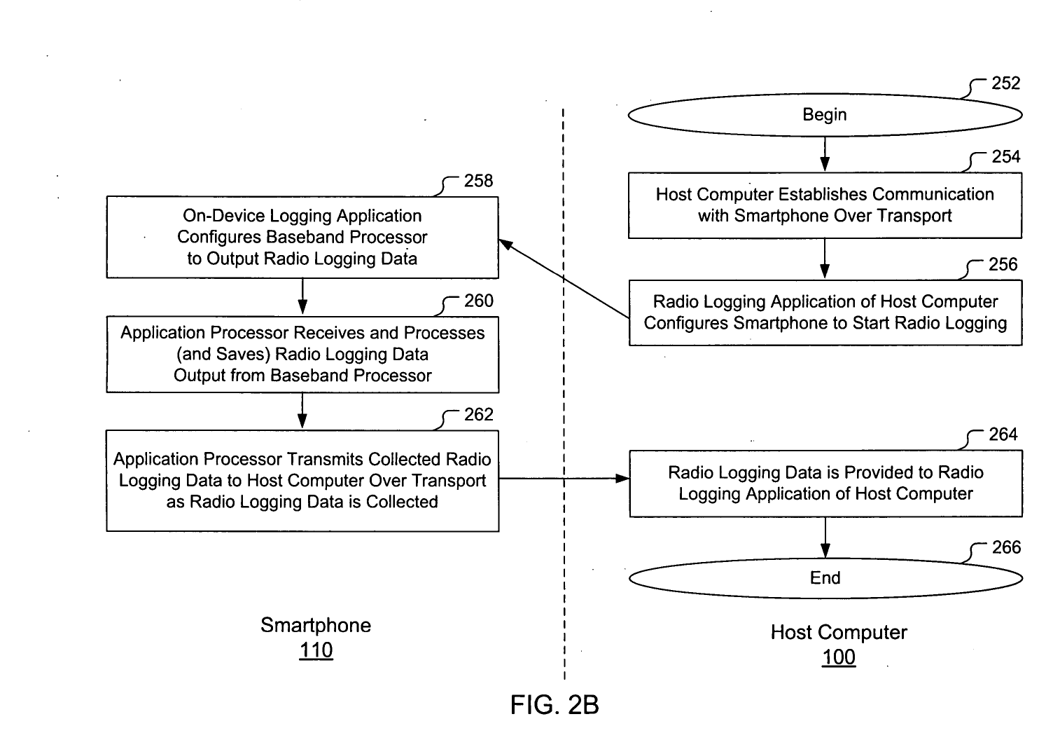

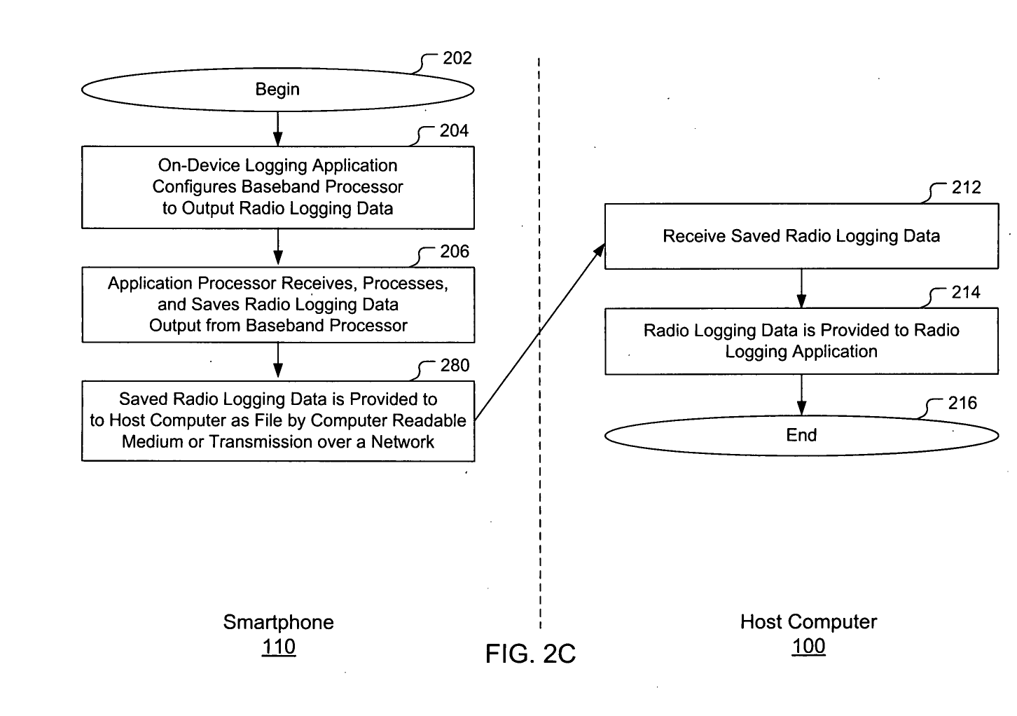

FIG. 2A is a flowchart illustrating a method of collecting radio logging data, according to one embodiment of the present invention. The embodiment shown in FIG. 2A illustrates the on-device logging application 190 collecting and saving the radio logging data on its own without interaction with the radio logging application 120 of the host computer 100 during the collection process, and then later on transmitting the saved radio logging data to the host computer 100. Thus, the radio logging application 120 of the host computer 100 receives past radio logging data previously stored in the smartphone 110, and it becomes possible to time-shift the review of the radio logging data in any manner.

As the process begins 202, the on-device logging application 190 of the smartphone 110 (running on the application processor 172) configures 204 the baseband processor 170 to output the radio logging data of interest. Note that the configuration 204 can occur entirely on the smartphone 110 without interaction with the host computer 100. The application processor 172 receives 206 the output radio logging data from the baseband processor 170, and processes and saves 206 the radio logging data. The radio logging data can be saved, for example, in the storage device 180. Then, when the application processor 172 detects 208 that communication between the smartphone 110 and the host computer 100 has been established, the application processor 172 causes 210 the saved radio logging data to be transmitted to the host computer 100 over the transport 115. The processor 102 of the host computer 100 receives 212 the radio logging data from the smartphone 110, which is provided 214 to the radio logging application 120 of the host computer 100 and the process ends 216.

FIG. 2B is a flowchart illustrating a method of collecting radio logging data, according to another embodiment of the present invention. The embodiment shown in FIG. 2B illustrates the on-device logging application 190 of the smartphone 110 collecting the radio logging data at the initiation of the radio logging application 120 of the host computer 100, while the host computer 100 and the smartphone 110 are in communication with each other. Thus, in this embodiment, a user viewing the collected radio logging data from the radio logging application 120 “thinks” that the radio logging application 120 of the host computer 100 is collecting radio logging data as with conventional radio logging applications running on the host computer 100, although in fact it is the on-device radio logging application 190 running on the smartphone 110 that actually collects the radio logging data.

As the process begins 252, the host computer 100 establishes 254 communication with the smartphone 110 over the transport 115. Once the host computer 100 and the smartphone 110 are in communication with each other, the radio logging application 120 of the host computer configures 256 the smartphone 110 to start radio logging by sending instructions to start the radio logging to the application processor 172 of the smartphone. Upon receipt of such instructions, the on-device radio logging application 190 (running on the application processor 172) configures 258 the baseband processor 170 to output the radio logging data of interest. The application processor 172 receives 260 the radio logging data output from the baseband processor 170, and processes (and optionally saves) 260 the radio logging data. The application processor 172 also causes 262 the collected radio logging data to be transmitted to the host computer 100 over the transport 115 as the radio logging data is being collected and processed, which is provided 264 to the radio logging application 120 of the host computer 100 and the process ends 266.

FIG. 2C is a flowchart illustrating a method of collecting radio logging data, according to still another embodiment of the present invention. The embodiment of FIG. 2C is substantially the same as the embodiment of FIG. 2A, except that steps 208 and 210 of FIG. 2A is replaced by step 280. In step 280, rather than transmitting the saved radio logging data over a transport to the host computer 100, the saved radio logging data is provided to the host computer 100 as a file, by way of a computer readable medium storing the file or by transmission (e.g., by email or short message service) of the file to the host computer 100 over a network.

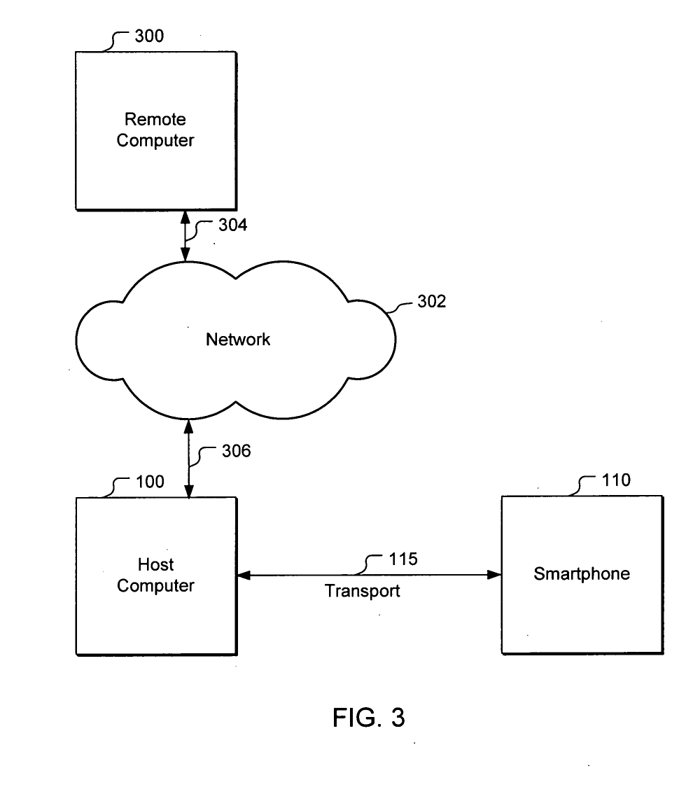

FIG. 3 illustrates a remote computer 300 communicating with the smartphone 110 through the host computer 100 over the transport 115 to receive the radio logging data collected in the smartphone 110, according to one embodiment of the present invention. In this embodiment, a user of the remote computer 300 can view the radio logging data that was collected by the on-device radio logging application 190 of the smartphone 110 and provided to the host computer 100 by either of the methods described in FIG. 2A, FIG. 2B, or FIG. 2C or any other method. For example, the radio logging data can be transmitted from the host computer 100 to the remote computer 300 through the network 302 as the radio logging data is being collected on the smartphone 110 and provided to the host computer 100 over the transport 115. Therefore, a technician at a remote location can have the radio logging data collected by the smartphone 110 for monitoring remotely from the remote computer 300.

Upon reading this disclosure, those of ordinary skill in the art will appreciate still additional alternative structural and functional designs for a system and a process for collecting radio logging data at the smartphone through the disclosed principles of the present invention. Note that the communication method of the present invention is applicable regardless of the type of operating systems used in the host computer and the smartphone and regardless of the type of radio or cellular communication standard used in the smartphone.

Thus, while particular embodiments and applications of the present invention have been illustrated and described, it is to be understood that the invention is not limited to the precise construction and components disclosed herein. Various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A method of collecting radio logging data of a first computing device including cellular telephone capabilities, the first computing device configurable to communicate with a second computing device, the method comprising:
collecting the radio logging data on the first computing device;
saving the radio logging data in the first computing device; and
providing the saved radio logging data to the second computing device.

2. The method of claim 1, wherein providing the saved radio logging data comprises:
responsive to establishing communication between the first computing device and the second computing device, transmitting the saved radio logging data to the second computing device over a transport coupled between the first computing device and the second computing device.

3. The method of claim 1, wherein providing the saved radio logging data comprises:
providing the saved radio logging data to the second computing device in a computer readable medium or by transmission over a network.

4. The method of claim 1, wherein the radio logging data is collected by a first radio logging application running on the first computing device.

5. The method of claim 4, wherein the saved radio logging data is provided to a second radio logging application running on the second computing device, the radio logging data collected at a first time and provided to the second radio logging application at a second time later than the first time.

6. A method of collecting radio logging data of a first computing device including cellular telephone capabilities, the first computing device configurable to communicate with a second computing device, the method comprising:
establishing communication between the first computing device and the second computing device;
responsive to receiving instructions from the second computing device to collect the radio logging data, collecting the radio logging data on the first computing device while the first computing device is in communication with the second computing device; and
transmitting the collected radio logging data to the second computing device.

7. The method of claim 6, further comprising:
saving the radio logging data in the first computing device.

8. The method of claim 6, wherein the radio logging data is collected by a first radio logging application running on the first computing device and the instructions to collect the radio logging data are provided from a second radio logging application running on the second computing device to the first radio logging application.

9. The method of claim 6, wherein the radio logging data is transmitted to the second computing device as the radio logging data is being collected on the first computing device.

10. The method of claim 6, wherein the radio logging data is further transmitted from the second computing device to a third remote computing device over a network as the radio logging data is being collected on the first computing device.

11. A first computing device with cellular telephone capabilities and including a storage device storing computer instructions adapted to perform a method of collecting radio logging data of the first computing device and a processor for executing the computer instructions, the first computing device configurable to communicate with a second computing device, the method comprising:
collecting the radio logging data on the first computing device;
saving the radio logging data in the first computing device; and
providing the saved radio logging data to the second computing device.

12. The first computing device of claim 11, wherein providing the saved radio logging data comprises:
responsive to establishing communication between the first computing device and the second computing device, transmitting the saved radio logging data to the second computing device over a transport coupled between the first computing device and the second computing device.

13. The first computing device of claim 11, wherein providing the saved radio logging data comprises:
providing the saved radio logging data to the second computing device in a computer readable medium or by transmission over a network.

14. The first computing device of claim 11, wherein the radio logging data is collected by a first radio logging application running on the first computing device.

15. The first computing device of claim 14, wherein the saved radio logging data is provided to a second radio logging application running on the second computing device, the radio logging data collected at a first time and provided to the second radio logging application at a second time later than the first time.

16. A first computing device with cellular telephone capabilities and including a storage device storing computer instructions adapted to perform a method of collecting radio logging data of the first computing device and a processor for executing the computer instructions, the first computing device configurable to communicate with a second computing device, the method comprising:
establishing communication between the first computing device and the second computing device;
responsive to receiving instructions from the second computing device to collect the radio logging data, collecting the radio logging data on the first computing device while the first computing device is in communication with the second computing device; and
transmitting the collected radio logging data to the second computing device.

17. The first computing device of claim 16, wherein the method further comprises:
saving the radio logging data in the first computing device.

18. The first computing device of claim 16, wherein the radio logging data is collected by a first radio logging application running on the first computing device and the instructions to collect the radio logging data are provided from a second radio logging application running on the second computing device to the first radio logging application.

19. The first computing device of claim 16, wherein the radio logging data is transmitted to the second computing device as the radio logging data is being collected on the first computing device.

20. The first computing device of claim 16, wherein the radio logging data is further transmitted from the second computing device to a third remote computing device over a network as the radio logging data is being collected on the first computing device.

21. A computer program product stored on a computer readable medium and adapted to perform a method of collecting radio logging data of a first computing device including cellular telephone capabilities, the first computing device configurable to communicate with a second computing device, the method comprising:
collecting the radio logging data on the first computing device;
saving the radio logging data in the first computing device; and
providing the saved radio logging data to the second computing device.

22. The computer program product of claim 21, wherein providing the saved radio logging data comprises:
responsive to establishing communication between the first computing device and the second computing device, transmitting the saved radio logging data to the second computing device over a transport coupled between the first computing device and the second computing device.

23. The computer program product of claim 21, wherein providing the saved radio logging data comprises:
providing the saved radio logging data to the second computing device in a computer readable medium or by transmission over a network.

24. The computer program product of claim 21, wherein the radio logging data is collected by a first radio logging application running on the first computing device.

25. The computer program product of claim 21, wherein the saved radio logging data is provided to a second radio logging application running on the second computing device, the radio logging data collected at a first time and provided to the second radio logging application at a second time later than the first time.

26. A computer program product stored on a computer readable medium and adapted to perform a method of collecting radio logging data of a first computing device including cellular telephone capabilities, the first computing device configurable to communicate with a second computing device, the method comprising:
establishing communication between the first computing device and the second computing device;
responsive to receiving instructions from the second computing device to collect the radio logging data, collecting the radio logging data on the first computing device while the first computing device is in communication with the second computing device; and
transmitting the collected radio logging data to the second computing device.

27. The computer program product of claim 26, wherein the method further comprises:
saving the radio logging data in the first computing device.

28. The computer program product of claim 26, wherein the radio logging data is collected by a first radio logging application running on the first computing device and the instructions to collect the radio logging data are provided from a second radio logging application running on the second computing device to the first radio logging application.

29. The computer program product of claim 26, wherein the radio logging data is transmitted to the second computing device as the radio logging data is being collected on the first computing device.

30. The computer program product of claim 26, wherein the radio logging data is further transmitted from the second computing device to a third remote computing device over a network as the radio logging data is being collected on the first computing device.
